(19) United States
(12) Patent Application Publication
(10) Pub. No.: US 2023/0361314 A1
(43) Pub. Date: Nov. 9, 2023

(54) Flexible Lithium Batteries Including Patterned Electrode Assemblies

(71) Applicant: The Johns Hopkins University, Baltimore, MD (US)

(72) Inventors: Nicholas G. Pavlopoulos, Columbia, MD (US); Jason E. Tiffany, Columbia, MD (US); Konstantinos Gerasopoulos, Gambrills, MD (US); Spencer A. Langevin, Silver Spring, MD (US); Matthew W. Logan, Columbia, MD (US)

(21) Appl. No.: 18/179,010

(22) Filed: Mar. 6, 2023

Related U.S. Application Data
(60) Provisional application No. 63/338,930, filed on May 6, 2022.

(51) Int. Cl. H01M 4/70; H01M 10/0525

(52) U.S. Cl. CPC H01M 4/70; H01M 10/0525

(57) ABSTRACT

Flexible lithium-ion batteries include patterned electrode assemblies configured to partition bending stresses when the lithium-ion battery is flexed by localizing high bending stresses. The patterned electrode assemblies can include a patterned current collector and active material or patterned active material formed on a current collector that is not patterned.

### CROSS-REFERENCE TO RELATED APPLICATIONS

This application claims the benefit of U.S. Provisional Patent Application Ser. No. 63/338,930, filed on May 6, 2022, which is expressly incorporated by reference herein in its entirety.

### STATEMENT REGARDING FEDERALLY SPONSORED RESEARCH OR DEVELOPMENT

This invention was made with Government support under Contract No. N00024-13-D-6400 awarded by the United States Department of the Navy. The Government has certain rights in the invention.

### BACKGROUND

The present disclosure generally relates to flexible lithium-ion batteries, and more particularly, lithium-ion batteries including patterned electrodes.

Wearable electronics are rapidly being developed for a wide range of healthcare, entertainment, and sports applications. Conventional power sources with bulky and rigid structures becomes a bottleneck for the rapid advancements of wearable smart electronics. To meet the requirement of next-generation wearable electronics, high performance rechargeable power supplies with high flexibility and bendability are desirable.

Lithium-ion batteries generally include a layered structure including a positive current collector, an anode (i.e., a positive active material), a separator, a cathode (i.e., a negative active material) and a negative current collector. This pattern can be repeated for up to hundreds of layers forming an effective composite laminate. Simple bending applied to this laminate can result in unbalanced shear forces acting on the layers through compressive and tensile stress exerted through the geometry of the bending. The cumulative tensile stress can result in damage to the electrode material and solid electrolyte interface, resulting in diminished performance and/or reduced safety. The cumulative compressive stress can cause buckling and separator damage, which can slow lead to diminished performance and/or reduced safety.

### BRIEF SUMMARY

Disclosed herein are flexible lithium-ion batteries and electrodes for the lithium ion batteries. In one or more embodiments, a flexible lithium-ion battery includes a positive electrode including a patterned positive current collector and a patterned positive active material provided on the patterned positive current collector; a porous separator; and a negative electrode including a patterned negative current collector and a negative active electrode material provided on the patterned negative current collector. The positive current collector includes at least one longitudinal rail and a plurality of spaced apart active segments perpendicularly oriented with respect to the at least one longitudinal rail, wherein the longitudinal rail comprises trench features having a reduced thickness at locations between the active segments. The patterned negative current collector includes at least one longitudinal rail and a plurality of spaced apart active segments perpendicularly oriented with respect to the at least one longitudinal rail, wherein the longitudinal rail comprises trench features having a reduced thickness at locations between the active segments.

In one or more other embodiments, the flexible lithium-ion battery includes a positive electrode including a rectangular-shaped positive current collector and a patterned positive active material provided on the positive current collector; a negative electrode including a negative rectangular shaped-current collector and a patterned negative active material provided on the negative current collector; and a porous separator intermediate the positive and the negative electrodes. The patterned positive and negative active materials have patterns configured to partition bending stresses when the lithium-ion battery is flexed by localizing high bending stresses to areas without the positive and the negative active material while maintaining relatively unstressed areas for the positive and the negative active material.

In one or more embodiments, an electrode assembly for a lithium-ion battery includes a patterned current collector comprising at least one longitudinal rail and a plurality of spaced apart active segments perpendicular to and extending from the rail, wherein the at least one longitudinal rail has a reduced thickness relative to a thickness of the spaced apart active segments is at locations between the spaced apart active segments, and wherein the at least one longitudinal rail includes a terminal end for connecting to an external electronic device.

In one or more other embodiments, the electrode assembly for a lithium-ion battery includes a current collector having a rectangular shape including a terminal end extending from the rectangular shape for connection to an external electronic device; and a patterned active material provided on the current collector comprising a pattern defined by a full thickness of the active material and areas free of active material.

The disclosure may be understood more readily by reference to the following detailed description of the various features of the disclosure and the examples included therein.

### BRIEF DESCRIPTION OF THE DRAWINGS

Referring now to the figures wherein the like elements are numbered alike:

FIG. 1 depicts a cross-sectional view of an exemplary lithium-ion battery including patterned electrodes in accordance with one or more embodiments of the present disclosure;

FIG. 2 pictorially illustrates top-down views of a positive current collector and a negative current collector in accordance with one or more embodiments of the present disclosure;

FIG. 3 depicts a cross-sectional view of a patterned current collector taken along the lines of a longitudinal rail in accordance with one or more embodiments of the present disclosure;

FIG. 4 illustrates a cross-sectional view of a patterned active material formed on a current collector that is not patterned in accordance with one or more embodiments of the present disclosure;

FIG. 5 graphically illustrates an initial cycle data for a seven-layer lithium-ion battery including patterned electrodes in accordance with the present disclosure;

FIG. 6 graphically illustrates cycle data for a seven-layer lithium-ion battery including patterned electrodes before and after bending in accordance with the present disclosure;

FIG. 7 graphically illustrates initial charge-discharge cycles for a lithium-ion battery including patterned electrodes in accordance with the present disclosure; and

FIG. 8 graphically illustrates cycle data for a lithium-ion battery including patterned electrodes after up to 400 flexure cycles in accordance with the present disclosure.

### DETAILED DESCRIPTION

Disclosed herein are flexible lithium-ion batteries configured to overcome the above noted problems in the art. In accordance with one or more embodiments of the present disclosure, the flexible batteries include patterned electrodes and processes for making the flexible batteries including the patterned electrodes. As will be discussed in greater detail herein, the patterned electrodes are configured to partition the bending stresses by localizing high bending stresses to areas without active electrode material, while maintaining relatively unstressed areas for the active electrode material. The patterned electrodes are generally defined by a current collector and an active material thereon, which can be positive-acting or negative-acting depending on the materials. In one or more embodiments in accordance with the present disclosure, the current collector is first patterned, and the active material subsequently provided thereon to create isolated regions of active material connected through thin foil, mesh or foam contacts defined by the patterned current collector. Optionally, the current collectors are first coated with the active materials followed by simultaneous patterning of both the current collector and the active material, thereby effectively cutting out regions of the coated current collector to form the pattered electrode. In one or more alternative embodiments, the active material of the electrode is selectively patterned while the current collector is left intact. Advantageously, the partitioned electrodes in the flexible lithium-ion batteries provide markedly improved flexural performance and adhesion with a minimal reduction in capacity. Moreover, the patterning of the electrodes is extensible to micro-scale dimensions.

Patterning can be provided by mechanical cutting, punching, laser cutting or etching, pressing with a patterned mask to compact select areas, or the like, wherein the process will generally depend on the length scale of the lithium-ion battery being targeted, e.g., macro-scale (centimeter to millimeter scale) to micro-scale (tens to hundreds of microns).

Conventional techniques related to lithium-ion battery fabrication and general structure may or may not be described in detail herein. Moreover, the various tasks and process steps described herein can be incorporated into a more comprehensive procedure or process having additional steps or functionality not described in detail herein. In particular, various steps in the fabrication of the lithium-ion battery as well as the general assembly and materials used therein are well known and so, in the interest of brevity, many conventional steps, structure, and materials, will only be mentioned briefly herein or will be omitted entirely without providing the well-known process details.

For the purposes of the description hereinafter, the terms “upper”, “lower”, “top”, “bottom”, “left,” and “right,” and derivatives thereof shall relate to the described structures, as they are oriented in the drawing figures. The same numbers in the various figures can refer to the same structural component or part thereof. Additionally, the articles “a” and “an” preceding an element or component are intended to be nonrestrictive regarding the number of instances (i.e., occurrences) of the element or component. Therefore, “a” or “an” should be read to include one or at least one, and the singular word form of the element or component also includes the plural unless the number is obviously meant to be singular.

Spatially relative terms, e.g., “beneath,” “below,” “lower,” “above,” “upper,” and the like, can be used herein for ease of description to describe one element or feature's relationship to another element(s) or feature(s) as illustrated in the figures.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

As used herein, the term “about” modifying the quantity of an ingredient, component, or reactant of the invention employed refers to variation in the numerical quantity that can occur, for example, through typical measuring and liquid handling procedures used for making concentrates or solutions. Furthermore, variation can occur from error in measuring procedures, differences in the manufacture, source, or purity of the ingredients employed to make the compositions or carry out the methods, and the like.

It will also be understood that when an element, such as a layer, region, or substrate is referred to as being “on” or “over” another element, it can be directly on the other element or intervening elements can also be present. In contrast, when an element is referred to as being “directly on” or “directly over” another element, there are no intervening elements present, and the element is in contact with another element.

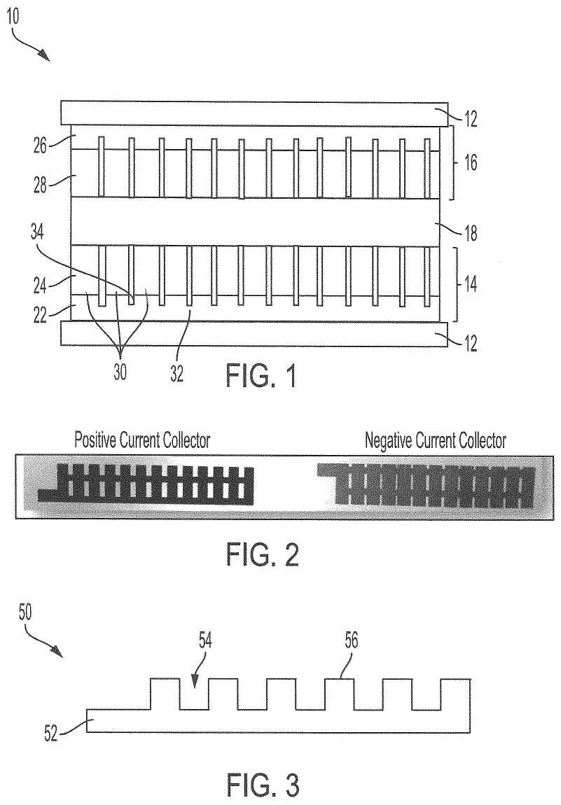

Referring now to FIG. 1, an exemplary planar flexible battery 10 in accordance with one or more embodiments of the present disclosure is depicted. The flexible battery 10 includes positive and negative electrode assemblies, 14, 16, respectively, a porous separator 18 intermediate the positive and negative electrode assemblies 14, 16, respectively, and an exterior material 12 on each side of the assembly sealed about a peripheral edge thereof encapsulating the electrode assembly along with an electrolyte (not shown). The electrode assemblies 14, 16 are typically sealed together with the electrolyte within the exterior material 12.

The positive electrode assembly 14, also referred to as the anode, includes a positive current collector 22 and a positive active material 24. The negative electrode assembly 16, also referred to as the cathode, includes a negative current collector 26 and a negative active material 28. The respective active materials 24, 28, may be compressed, deposited, or coated on one surface of the current collectors 22, 26, respectively, as is generally shown or both surfaces for two-sided electrode applications (not shown). For convenience, reference will be made herein to a laminate structure including a one-sided electrode including the positive current collector, the positive active material, the separator, the negative active material, and the negative current collector as is generally described above. However, it should be apparent that this layered structure can be, and is often, repeated for up to hundreds of layers depending on the capacity of the laminated lithium-ion battery construction being fabricated. For flexible batteries in accordance with the present disclosure, the number of layers is generally less than 100. In other embodiments, the number of layers is generally less than 50.

In one or more embodiments, the current collector 22 or 26, which is typically a rectangularly-shaped foil, mesh or foam, is patterned to define a plurality of spaced apart active segments 30 at a full thickness and at least one longitudinal rail 32, wherein the active segments 30 perpendicularly extend from the at least one longitudinal rail 32, which has a reduced thickness at locations between the active segments. The openings between the spaced apart active segments and the reduction of thickness in the longitudinal rail at locations between active segments can be effected by the formation of trench features such as by mechanical cutting, punching, or laser cutting. Each of the spaced apart active segments 30 are thus interconnected with one another by patterning the trench features therebetween to define the longitudinal rail at the reduced thickness, which can extend up to about the full thickness of the current collector utilized within the electrode assembly.

In one or more embodiments, the trench features at locations between active segments are less than 90 percent to greater than 10 percent of the overall thickness of the current collector. In other embodiments, the trench features are less than about 75 percent of the thickness to greater than 10 percent of the overall thickness of the current collector, and in still one or more embodiments, the trench features are less than about 50 percent to greater than 20 percent of the overall thickness of the current collector.

Pattering the current collectors with the reduced thickness of the longitudinal rail between active segments provides the battery with improved flexibility and better adhesion during flexure with minimal capacity reduction. Strain is markedly reduced by enforcing bending along the thinner areas of the longitudinal rail. The spacing between active segments is not intended to be limited so long as the strain is reduced by enforcing bending at the thinner trench locations along the rail. Generally, the resulting electrode shapes are micropatterned to retain about 70 percent to about 82 percent of the rectangular outline area/storage capacity of a typical non-patterned electrode structure.

FIG. 2 pictorially illustrates top-down views of a positive current collector and a negative current collector as labeled. As shown, both current collectors include a plurality of spaced apart active segments perpendicularly oriented and spanning two longitudinal spaced apart rails. The number of active segments for most applications can be between 6 and 12, although lesser or higher numbers of active segments can be used. It is also noted that each of the active segments in the negative current collector have about a 10 percent size increase relative to the active segments of the positive current collector, which provides sufficient overlay tolerance when the lithium-ion battery is assembled and helps to prevent shorting of the completed cell during charging, and the like. Terminals can be provided for each respective current collector as shown for electrical connection to an external device. As such, the respective terminals may protrude from one side of the current collector and, when assembled, the exterior material (not shown) encapsulating the battery structure, or may be provided to be exposed from at any surface location of the exterior material.

FIG. 3 illustrates a cross-sectional view of an exemplary current collector 50 taken along the lines of the longitudinal rail 52. As shown, trench features 54 are at a depth less than the full thickness of the current collector are provided between spaced apart active segments 56. Although the spacing between the spaced apart segments are regular and periodic, it should be apparent that the spacing can vary between the active segments as may be desired for some applications. Likewise, the number of rails is not intended to be limited so long as at least one rail is present. Two spaced part rails such as that shown in current collectors of FIG. 2 provide improved handling and structural stability.

The patterning of the current collectors to define the active segments and the trench features can be by mechanical cutting, punching, laser cutting or the like. For example, laser cutting can be utilized to provide rapid patterning of the rather complex shape of the current collectors. For microscale dimensions, ultrashort pulse lasers such as those operating in the nanosecond and picosecond regimes can be used to provide the patterning, which can also provide minimal edge roughness. These lasers are commercially available with different outputs wavelength and provide minimal heat affected zones given the short pulses associated with the use of these types of lasers.

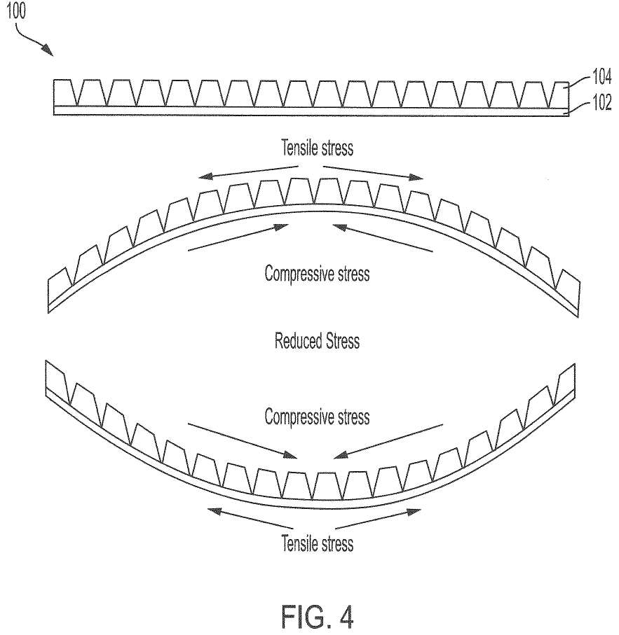

FIG. 4 illustrates a cross-sectional view of an electrode assembly 100 in accordance with another embodiment of the present disclosure. The electrode assembly includes a rectangular-shaped current collector 102 and an active material 104, wherein only the active material is patterned, and the current collector is left intact. The patterning can be configured to provide increased flexibility in one direction or multiple directions. For example, in one embodiment, the patterned active material includes a plurality of lines and spaces extending across a width of the rectangular shaped current collector. In this configuration, flexibility along the length of the electrode is increased as is generally shown, which reduces both tensile and compressive stress. The bending stresses are partitioned by localizing high bending stresses to areas without any active electrode material, while maintaining relatively unstressed areas for the active electrode material.

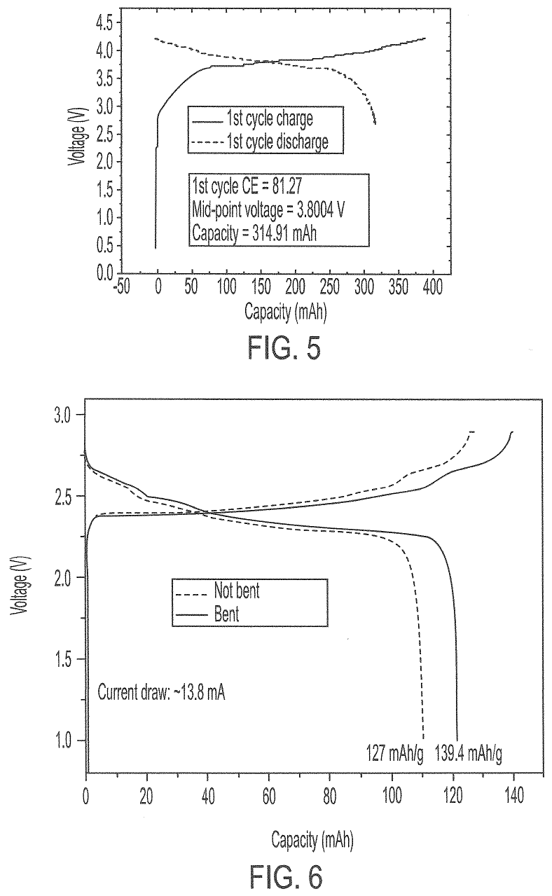

FIG. 5 graphically illustrates cycle data for a seven-layer lithium-ion battery including patterned electrodes to provide 82% functional battery area. The seven-layer structure included a patterned positive current collector, the positive active material provided thereon, the separator, the negative active material, the patterned negative current collector, and an electrolyte as is generally described above encapsulated within an inert exterior material. The initial cycle data as shown advantageously yielded a capacity of 314.91 mAh that was directly proportional to the 82% functional battery area.

FIG. 6 graphically illustrates cycle data for a flexible lithium-ion battery including three electrode pairs, wherein the electrodes in each pair were patterned in accordance with the present disclosure. The anodes within the electrode pair were constructed of a 10-micron thick copper foil onto which an aqueous slurry of an active material including graphite, polyvinylidene fluoride binder, and a conductive additive of C65 was deposited. C65 is a nano carbon black commercially available from MSE Supplies, LLC and is generally used in the art to increase cycling performance. The cathodes were constructed of a 10-micron thick aluminum foil onto which an active material was deposited. The active material was deposited as an organic slurry in N-methyl-2-pyrrolidone and included lithium cobalt oxide, polyvinylidene fluoride binder, and C65 conductive additive. The cathodes were coated at about 200-micron thickness to result in a 60- to 80-micron thick electrode. The anodes were coated to result in an excess capacity of at least 10% relative to the cathode loading. Cycle data was obtained before and after bending, wherein bending included rolling the lithium-ion battery into a cylinder-like shape approximating a circumference of an average human wrist. As shown, performance did not degrade when the battery was tested under the bent condition.

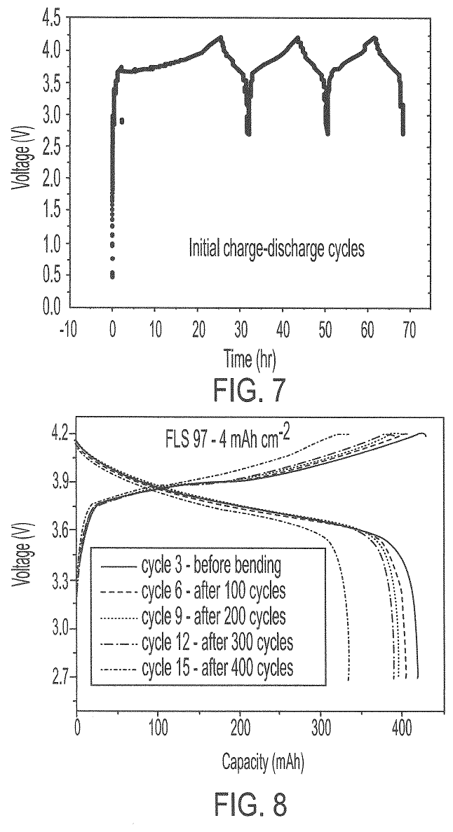

FIG. 7 graphically illustrates initial charge-discharge cycles for a flexible lithium-ion battery including three electrode pairs, wherein the electrodes in each pair were patterned in accordance with the present disclosure. The anodes within the electrode pair were constructed of a 10-micron thick copper foil onto which an aqueous slurry of an active material including graphite, polyvinylidene fluoride binder, and a conductive additive of C65 was deposited. The cathodes were constructed of a 10-micron thick aluminum foil onto which an active material was deposited. The active material was deposited as an organic slurry in N-methyl-2-pyrrolidone and included lithium cobalt oxide, polyvinylidene fluoride binder, and C65 conductive additive. The cathodes were coated at about 200-micron thickness to result in a 60- to 80-micron thick electrode. The anodes were coated to result in an excess capacity of at least 10% relative to the cathode loading. As shown, the initial charge-discharge cycles were substantially identical to one another.

FIG. 8 graphically illustrates cycle data for a lithium-ion battery in accordance with the present disclosure after multiple flexure cycles. The electrodes in this example were fabricated with higher electrode coating thicknesses than the electrodes fabricated for the previous examples of FIGS. 6 and 7 above. In particular, the anode was constructed of a 10-micron thick copper foil onto which an aqueous slurry of an active material was deposited. The active material included graphite, a carboxymethyl cellulose-styrene butadiene rubber binder, and C65 conductive additive. The cathode was constructed of a 10-micron thick aluminum foil onto which an organic slurry of an active material was deposited. The active material included lithium cobalt oxide, PVDF binder, and C65 conductive additive. The cathodes were coated at a thickness of about 500 microns, which resulted in a thickness of about 120 to 160 microns when dried. The anodes were coated to result in an excess capacity of at least 10% relative to the cathode loading. The flexure cycle included a flexural protocol that included bending the battery about an approximately 1-inch radius fixture at a 2-inch displacement and a rate of about 1 Hz. As shown, it was only after 300 plus flexure cycles that capacity retention decreased during the discharging cycle.

In the various lithium-ion battery constructions described above, the current collectors may be formed of a thin metallic foil, mesh or foam, and may be made of, for example, copper, aluminum, stainless steel, nickel, titanium, chromium, manganese, iron, cobalt, zinc, molybdenum, tungsten, silver, gold, and a mixture thereof. The current collectors generally have a thickness prior to patterning that generally ranges from about 6 to 50 microns (μm).

The positive electrode active materials may be selected to reversibly perform intercalation and deintercalation on lithium ions, and as a representative non-limiting example of the positive electrode active material, one of lithium-transition metal oxide such as LiCoO₂, LiNiO₂, LiNiCoO₂, LiMnO₂, LiMn₂O₄, V₂O₅, V₆O₁₃, LiNi_{1-x-y}CoₓM_{y}O₂ (0≤x≤1, 0≤x+y≤1, M is a metal such as Al. Sr, Mg. and La) and an NCM (lithium nickel cobalt manganese) based active material may be used, and a mixture in which one or more of these materials are mixed may be used. Additionally, other active materials can include those utilized in lithium sulfur battery chemistries. e.g., sulfur- or selenium-based conversion cathodes.

The negative electrode active material may be selected to reversibly perform intercalation and deintercalation on lithium ion. The negative electrode active material may be selected from a group consisting of crystalline or amorphous carbon, carbon fiber, or a carbon-based negative electrode active material of a carbon composite, tin oxide, a lithiated material thereof, lithium lithium alloy, and a mixture in which one or more of these materials are mixed. The carbon-based negative electrode active material may be one or more materials selected from a group consisting of a carbon nanotube, a carbon nanowire, a carbon nanofiber, graphite, active carbon, graphene pin, and graphite.

It should be noted that the current collectors, the positive electrode active material, and the negative electrode active material used in the present disclosure are not intended to be limited thereto and it is identified that the positive and negative current collectors and the respective active materials generally used in the art may be used.

In one or more embodiments, a polytetrafluoroethylene (PTFE) component may be contained in the active material to further prevent the active material active material from being released from the current collectors or from cracks being generated when flexed.

The separator intermediate the positive and negative electrode assemblies, e.g., electrodes 14, 16, respectively, can be a porous nonwoven layer. Exemplary porous nonwoven layers include, but are not intended to be limited to, polyolefins such as polypropylene, polyethylene, or the like, polyesters such as polyethylene terephthalate, or the like, and cellulose fiber. A thickness may be set in a range of 10 to 40 μm, a porosity may be set to 5 to 55%, and a Gurley value may be set to 1 to 1,000 sec/100c.

The liquid electrolyte for a lithium-ion battery is not intended to be limited and can include an aprotic solvent and a lithium salt, such as lithium hexafluorophosphate (LiPF₆) or lithium bis trifluoromethanesulfonyl)imide (LiTFSI). Examples of suitable solvents include ethylene carbonate, dimethyl carbonate, diethyl carbonate, methylpropyl carbonate, ethylpropyl carbonate, ethylmethyl carbonate, butylene carbonate, ethylene carbonate, propylene carbonate, vinyl carbonate, dialkylsulfites, fluoroethylene carbonate, poly(ethylene glycol) dimethacrylate, poly(ethylene glycol) dimethacrylate and combinations thereof. In further embodiments, the liquid electrolyte includes an ionic liquid. Still further, nitrile-based electrolytes can be used in the flexible lithium-ion batteries in accordance with the present disclosure.

Additionally, the electrolyte in the flexible lithium-ion batteries in accordance with the present disclosure can include solid gel-polymer electrolytes, solid polymer electrolytes, and the like.

While this specification contains many implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A flexible lithium-ion battery comprising:
a positive electrode comprising a patterned positive current collector and a patterned positive active material provided on the patterned positive current collector, wherein the positive current collector comprises at least one longitudinal rail and a plurality of spaced apart active segments perpendicularly oriented with respect to the at least one longitudinal rail, wherein the longitudinal rail comprises trench features having a reduced thickness at locations between the active segments;
a porous separator; and
a negative electrode comprising a patterned negative current collector and a negative acting material provided on the patterned negative current collector, wherein the patterned negative current collector comprises at least one longitudinal rail and a plurality of spaced apart active segments perpendicularly oriented with respect to the at least one longitudinal rail, wherein the longitudinal rail comprises trench features having a reduced thickness at locations between the active segments.

2. The flexible lithium-ion battery of claim 1, wherein the reduced thickness of the longitudinal rail at locations between the active segments is less than about 90 percent of the thickness to greater than 10 percent of the overall thickness of the respective patterned positive or negative current collector.

3. The flexible lithium-ion battery of claim 1, wherein the reduced thickness of the longitudinal rail at locations between the active segments less than about 75 percent to greater than 10 percent of the overall thickness of the respective patterned positive or negative current collector.

4. The flexible lithium-ion battery of claim 1, wherein the reduced thickness of the longitudinal rail at locations between the active segments is less than about 50 percent to greater than 20 percent of the overall thickness of the respective patterned positive or negative current collector.

5. The flexible lithium-ion battery of claim 1, wherein the positive and negative electrodes are configured to retain about 70 to about 82 percent of storage capacity relative to the positive and negative electrodes without patterning of the positive and the negative current collector.

6. The flexible lithium-ion battery of claim 1, wherein each of the positive and the negative current collectors have two spaced apart longitudinal rails, wherein the respective spaced apart active segments span the two spaced apart longitudinal rails.

7. The flexible lithium-ion battery of claim 1, wherein the patterned positive current collector is about 10 percent larger in length and width dimensions than the patterned negative current collector.

8. A flexible lithium-ion battery comprising:
a positive electrode comprising a rectangular-shaped positive current collector and a patterned positive active material provided on the positive current collector;
a negative electrode comprising a negative rectangular shaped-current collector and a patterned negative active material provided on the negative current collector; and
a porous separator intermediate the positive electrode and the negative electrode,
wherein the patterned positive and negative active materials have patterns configured to partition bending stresses when the lithium-ion battery is flexed by localizing high bending stresses to areas without the positive and the negative active material while maintaining relatively unstressed areas for the positive and the negative active material.

9. The flexible lithium-ion battery of claim 8, wherein each of the patterned positive and negative active materials comprise a plurality of lines and spaces.

10. The flexible lithium-ion battery of claim 8, wherein the patterned positive and negative active materials are configured to retain about 70 to about 82 percent of storage capacity relative to the positive and negative current collector without patterning.

11. The flexible lithium-ion battery of claim 8, wherein the positive current collector is about 10 percent larger in length and width dimensions than the negative current collector.

12. The flexible lithium-ion battery of claim 8 further comprises additional pairs of the positive and the negative electrodes.

13. An electrode assembly for a lithium-ion battery, the electrode assembly comprising:
a patterned current collector comprising at least one longitudinal rail and a plurality of spaced apart active segments perpendicular to and extending from the rail, wherein the at least one longitudinal rail has a reduced thickness relative to a thickness of the spaced apart active segments is at locations between the spaced apart active segments, and wherein the at least one longitudinal rail includes a terminal end for connecting to an external electronic device.

14. The electrode assembly of claim 13, wherein the electrode assembly including the patterned current collector is configured to retain about 70 to about 82 percent of storage capacity relative to the same electrode assembly including the current collector without patterning.

15. The electrode assembly of claim 13, wherein the patterned current collector comprises two spaced apart longitudinal rails, wherein the spaced apart active segments span the two spaced apart longitudinal rails.

16. The electrode assembly of claim 13 further comprising an active material provided on the patterned current collector.

17. An electrode assembly for a lithium-ion battery, the electrode assembly comprising:
a current collector having a rectangular shape including a terminal end extending from the rectangular shape for connection to an external electronic device; and
a patterned active material provided on the current collector comprising a pattern defined by a full thickness of the active material and areas free of active material.

18. The electrode assembly of claim 17, wherein the current collector comprises a foil, mesh or a foam.

19. The electrode assembly of claim 17, wherein the current collector is flexible.

20. The electrode assembly of claim 17, wherein the pattern comprises lines and spaces.

21. The electrode assembly of claim 17, wherein the electrode assembly including the patterned active material is configured to retain about 70 to about 82 percent of storage capacity relative to the same electrode assembly including the active material without patterning.
